(19) United States
(12) Patent Application Publication
(10) Pub. No.: US 2006/0090135 A1
(43) Pub. Date: Apr. 27, 2006

(54) Job guiding system

(76) Inventor: Takahito Fukuda, Osaka-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/517,487

(22) PCT Filed: Jun. 20, 2003
(86) PCT No.: PCT/JP03/07852

§ 371 Date: Jul. 7, 2005

(30) Foreign Application Priority Data
Jun. 20, 2002 (JP) 2002-180260

(51) Int. Cl. G06F 3/00; G06F 17/00; G06F 9/00

(52) U.S. Cl. 715/727

(57) ABSTRACT

The operation guiding system 1 includes a virtual image memory segment 17A, a glass section 11, a virtual image replay function 193A, and a virtual image adjusting function 193B. The virtual image memory segment 17A stores, with respect to an operation composed of a sequence of operation steps, virtual images for explaining a content of each of the operation steps. The glass section 11 is positioned in front of the operator's eye for displaying the virtual images, in contrast to a real operation object in front of the operator. The virtual image replay function 193A replays the virtual images on the glass section in order of the operation steps. The virtual image adjusting function 193B adjusts the virtual images such that a virtual operation object drawn on each of the virtual images will have an overlapping relation with the corresponding real operation object on the display unit.

### TECHNICAL FIELD

The present invention relates to an operation guiding system which guides an operator so that the operator can accurately perform an operation composed of a sequence of operation steps.

### BACKGROUND ART

When an operator begins an operation at a manufacturing floor etc., he usually begins the operation after he listened to the content of the operation from an instructor.

However, when the operator has to perform an operation composed of a sequence of operation steps, he may stop the operation or perform an improper operation if he runs into an unclear point or has an indistinct memory of the content of the operation. Although there is a way that the operator performs the operation while listening to the explanation of the operation from the instructor, it is inefficient because the instructor always has to be around the operator.

### DISCLOSURE OF THE INVENTION

In view of the above problem, the object of the present invention is to provide an operation guiding system which guides an operator so that the operator can accurately perform an operation composed of a sequence of operation steps without an instructor.

The operation guiding system in accordance with the present invention comprises a virtual image memory, a display unit, a virtual image replay means, and a virtual image adjusting means. The virtual image memory is configured to store, with respect to an operation composed of a sequence of operation steps, virtual images for explaining a content of each of the operation steps. The display unit is configured to be positioned in front of an operator's eye for displaying the virtual images, in contrast to a real operation object in front of the operator. The virtual image replay means is configured to replay the virtual images on the display unit in order of the operation steps. The virtual image adjusting means is configured to adjust the virtual image such that a virtual operation object drawn on each of the virtual images and corresponding to the real operation object will have an overlapping relation with the real operation object on the display unit.

Therefore, the operator can accurately perform an operation composed of a sequence of operation steps without an instructor, by only watching the virtual images on the display unit and performing the operation according to the virtual images with respect to the real operation object on which the virtual image is overlapped. The operator may begin the operation after watching all the virtual images to understand the whole operation. Because this operation guiding system includes the virtual image adjusting means, the virtual operation object drawn on the virtual image can keep the overlapping relation with the real operation object on the display regardless of the operator's position or the height of the operator's eye. Therefore, the operator can perform the operation efficiently.

Preferably, the virtual image includes a line drawing which outlines the real operation object and a visual information mark for visually explaining the content of the operation step. The line drawing facilitates visualization of the real operation object as well as the virtual operation object when they overlap each other, and the visual information mark can visually and easily convey the information that the operator should know for the operation, to the operator. So, the operator can perform the operation more accurately.

Furthermore, the operation guiding system preferably includes a visual information mark input means which calls up the virtual image from the virtual image memory to modify the visual information mark thereof and/or add the visual information mark thereto. Including the visual information mark input means enables the system to change flexibly, even if an operation direction is changed or new information that the operator should know arises. In this case, it is preferable that the virtual image comprises a layer on which the line drawing is drawn and a layer on which the visual information mark is drawn. Such virtual image can prevent an accidental deletion of the complicated line drawing and can provide a worry-free modification and/or a worry-free addition of the visual information mark.

Preferably, the virtual image replay means memorizes a correspondence between the virtual image and the operation step and has a function that calls up the virtual image corresponding to the operation step specified by the operator. Such function enables the operator to replay the virtual image that he needs quickly, even if the operation is composed of many operation steps.

It is also preferable that the virtual image replay means memorizes a correspondence between the virtual image and the operation step and has a function that replays the virtual images corresponding to the steps within a range specified by the operator and returns to the first virtual image in the range after the replay. In this case, the operator can watch the virtual images in a range that he needs in order to understand the whole operation, and then he can start the operation quickly in keeping with the replay of the virtual image because the virtual image has returned to the first step in the specified range after the replay.

Furthermore, the operation guiding system preferably includes a voice input means for inputting the operator's voice and a voice recognition means that recognizes the voice inputted using the voice input means. The virtual image replay means controls the replay of the virtual images based on the operator's voice. In this case, the operator can control the replay of the virtual images with hands full of tools, etc., so the operation efficiency can be improved more.

Furthermore, the operation guiding system preferably includes a voice memory for storing voice data which explains the content of the operation steps, and a voice output means for outputting the voice data. The virtual image replay means outputs the voice data to the voice output means in synchronization with a replay of the virtual images. In this case, the operator can receive the voice explanation about the operation in addition to the virtual image, so that he can understand the content of the operation more accurately. The voice data can explain the information which the virtual image can not be expressed.

The virtual image adjusting means may include an image pickup means for taking an image of the real operation object and a feature point extraction means for extracting a feature point decided in advance with respect to the operation object, from the image taken by the image pickup means, and, the virtual image adjusting means may change a position and/or a dimension of the virtual image displayed on the display unit automatically so that a position of a point of the virtual operation object which corresponds to the feature point extracted by the feature point extraction means will conform to the position of the feature point. In this case, even if the operator changes his position during the replay of the virtual image, the virtual image is adjusted automatically, and the virtual operation object can keep the overlapping relation with the real operation object.

Alternatively, the virtual image adjusting means may include a manual controller by which the operator can change the position and/or the dimension of the virtual image displayed on the display unit manually. In this case, the operator can bring the virtual operation object into the overlapping relation with the real operation object by hand. In this case, the operation guiding system preferably includes a head tracking means for tracking a motion of the operator's head, and the virtual image adjusting means corrects the position of the virtual image displayed on the display unit based on the output of the head tracking means. By including the head tracking means, once the operator brings the virtual operation object into the overlapping relation with the real operation object by the manual controller, the virtual operation object in the virtual image can keep the overlapping relation with the real operation object even if the operator moves his head.

### BRIEF DESCRIPTION OF THE DRAWINGS

FIG. 1 is a block diagram of an operation guiding system in accordance with a first embodiment of the present invention.

FIGS. 2A, 2B, and 2C are examples of the virtual images used in the operation guiding system.

FIG. 3 is a picture, as a substitute for a drawing, obtained by printing an image showing feature points of an engine as an operation object.

FIGS. 4A and 4B are pictures, as substitutes for drawings, obtained by printing images displayed on a display unit of the operation guiding system.

FIG. 5 is a picture, as a substitute for a drawing, obtained by printing an image displayed on a display unit of the operation guiding system.

FIG. 6 is a picture, as a substitute for a drawing, obtained by printing an image displayed on a display unit of the operation guiding system.

FIG. 7 is a diagram showing another construction of a glass section of the operation guiding system.

FIG. 8 is a block diagram of the operation guiding system in accordance with a second embodiment of the present invention.

FIG. 9 is a picture, as a substitute for a drawing, obtained by printing an image displayed on a display unit of the operation guiding system.

FIG. 10 is a picture, as a substitute for a drawing, obtained by printing an image displayed on a display unit of the operation guiding system.

FIG. 11 is a picture, as a substitute for a drawing, obtained by printing an image displayed on a display unit of the operation guiding system.

### BEST MODE FOR CARRYING OUT THE INVENTION

Hereinafter, the present invention will be described in more detail with reference to the accompanying drawings.

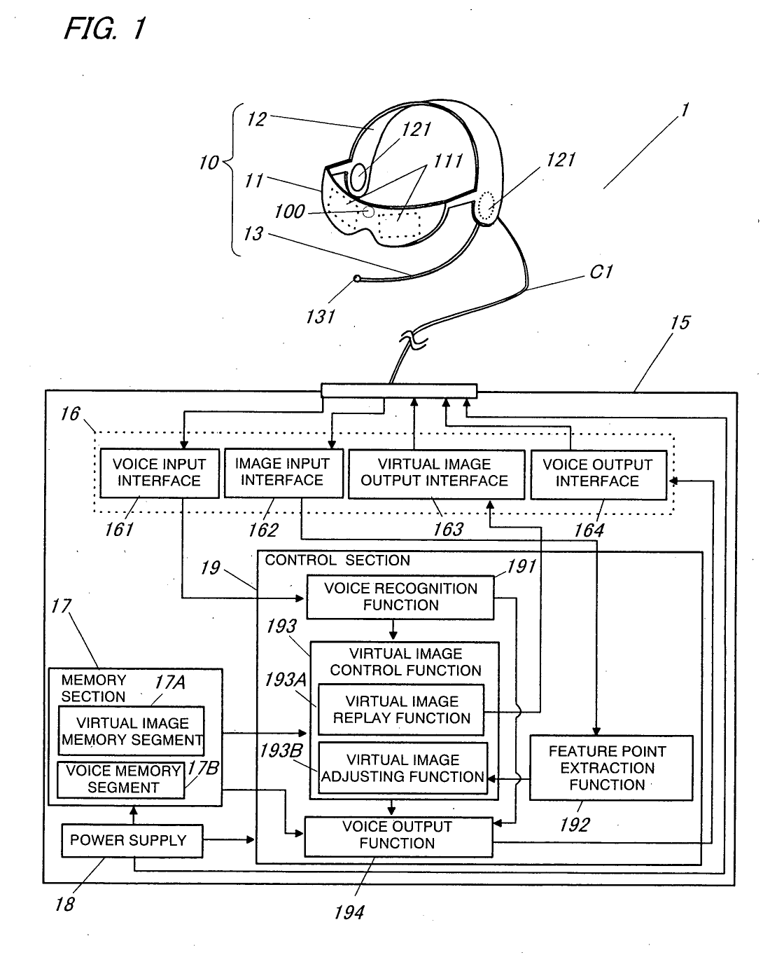

FIG. 1 shows an operation guiding system 1 in accordance with a first embodiment of the present invention. In this embodiment, the operation guiding system 1 is configured to be used in a manufacturing floor in which an engine is assembled, and it leads an operator so that he or she can accurately perform an engine assembly operation.

The operation guiding system 1 includes a head mounted AV (audio and visual) unit 10 and an operation guiding control unit 15 connected electrically to the AV unit 10 through a cable C1.

The AV unit 10 is composed of an integrated combination of a glass section 11 as a display unit, a headphone section 12 as a voice output means, a microphone section 13 as a voice input means, and a CCD camera 100 as an image pickup means. The glass section 11 is like a so-called see-through head mounted display, and it has a pair of translucent liquid crystal panels 111. The headphone section 12 has a pair of headphone speakers 121. The microphone section 13 has a microphone 131. The CCD camera 100 takes an image of the engine as an operation object from the operator's line of sight. The operator can see the real object through the translucent liquid crystal panels 111 in a state where a virtual image, as described later, is displayed on the crystal panels 111. In other words, the glass section 11 can display the virtual image, in contrast to a real image.

The operation guiding control unit 15 comprises an interface section 16, a memory section 17, a power supply 18, and a control section 19.

The interface section 16 includes a voice input interface 161, an image input interface 162, a virtual image output interface 163, and a voice output interface 164. The voice input interface 161 amplifies an analog voice signal from the microphone 131 and converts it into a digital voice signal and outputs to the control section 19. The image input interface 162 converts an analog image signal form the CCD camera 100 into a digital image data and outputs to the control section 19. The virtual image output interface 163 is based on the DVI (Digital Visual Interface) standard, and it connects between the control section 19 and the liquid crystal panels 111. The voice output interface 164 converts a voice data from the control section 19 into an analog voice signal and amplifies it based on a gain corresponding to a position of a volume control (not shown) and outputs to the headphone speakers 121.

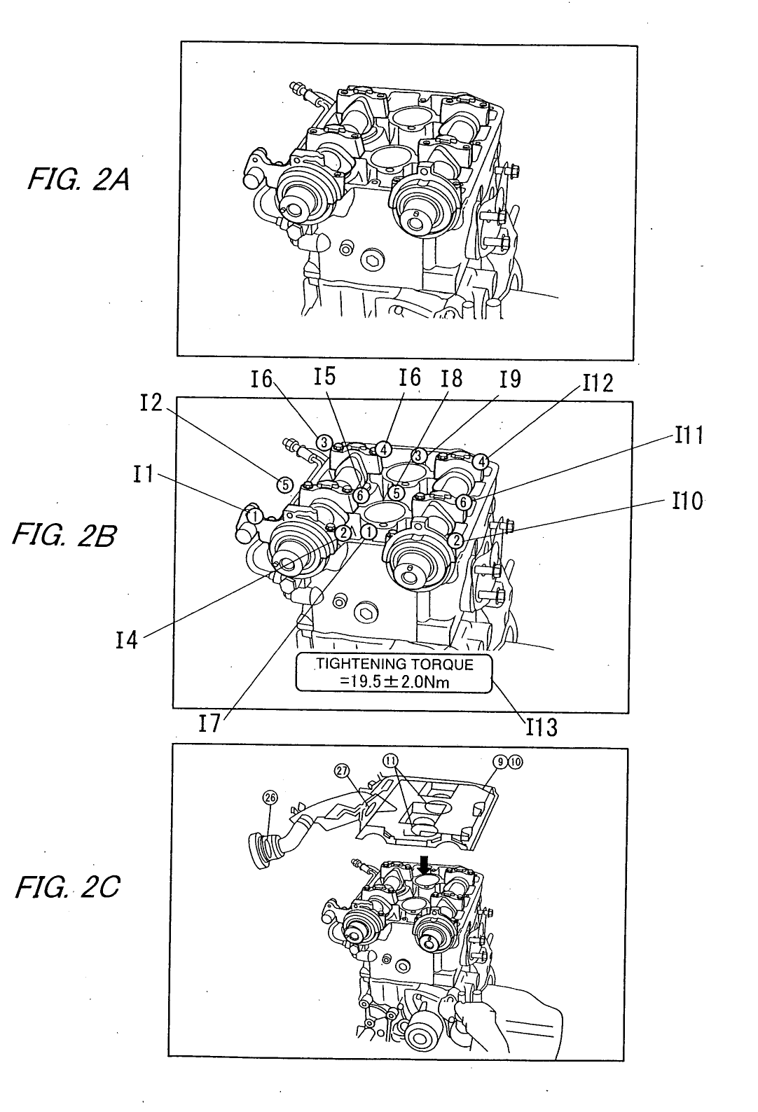

The memory section 17 is a storage device such as a hard disk, and it includes a virtual image memory segment 17A and a voice memory segment 17B. The virtual image memory segment 17A stores, with respect to the assembly operation of the engine composed of a sequence of a plurality of operation steps, the virtual images for explaining a content of each of the operation steps. Each of the virtual images is created based on a line drawing that draws an outline (in other words, an outer shape) of the operation object, and a visual information mark for explaining the content visually is added thereto as needed. The visual information mark is, for example, a number showing an operation order, an arrow showing a direction in which the operation is performed, text information, a completion drawing of the operation shown by dashed lines, and so on. FIGS. 2A, 2B, and 2C show examples of the virtual images. They are for explaining one operation of the engine assembly operation in which the operator fastens a bolt to an engine block and then attaches an engine cover thereto. FIG. 2A is a virtual image in which an outline of the engine block before the operation is drawn. FIG. 2B is a virtual image corresponding to a step in which the operator will fasten the bolts. FIG. 2C is a virtual image corresponding to a step in which the operator will attach the engine cover. Referring to FIG. 2B for example, the virtual image is created based of a line drawing that draws an outline of the engine as the operation object, and visual information marks I1 to I13, composed of numbers and text information, are added thereto. The visual information marks I1 to I12 show the order in which the operator is supposed to fasten the bolts, and the visual information mark I13 shows tightening torque of the bolts. The voice memory segment 17B stores voice data for explaining the content of each of the operation steps, such as an operation sequence, information associated with Product Liability Law, cautions, and so on. For example, the voice data replayed in synchronization with FIG. 2B is as follow: “In this step, you are supposed to fasten bolts in the order from 1 to 6. At that time, the tightening torque is 19.5±2.0 Nm”. By using the voice data and the visual information mark appropriately, the operator can understand the operation content more easily and can perform the operation accurately. It is preferable that an explanation which the operator can understand if he listens once (for example, an outline of the operation) is created as voice data and an explanation which the operator can not understand if he listens to only once (for example, an operation sequence, detailed numerical value, etc.) is created as a visual information mark.

The control section 19 is configured to control the whole operation guiding system 1, and it comprises a CPU (Central Processing Unit) for performing a predetermined program, main memory, and so on. The control section 19 has a voice recognition function 191, a feature point extraction function 192, a virtual image control function 193, and a voice output function 194.

The voice recognition function 191 recognizes the voice data, which is inputted from the microphone 131 and taken in through the voice input interface 161, and controls a virtual image replay function 193A according to the recognized voice. For example, when the voice recognition function 191 recognizes the term “Start replay”, it issues an instruction to the virtual image replay function 193A to start the replay of the virtual image.

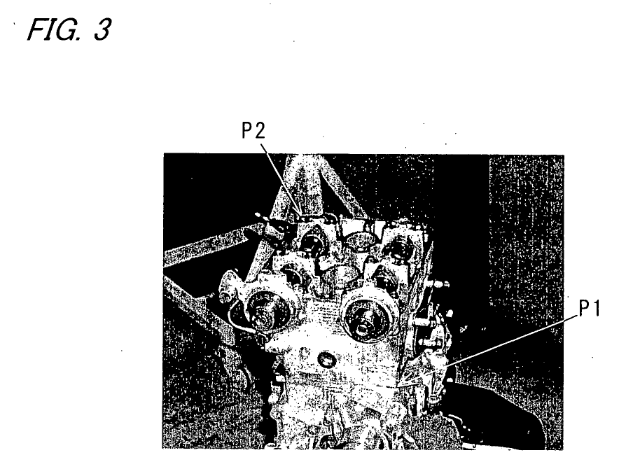

The feature point extraction function 192 extracts feature points decided in advance with respect to the engine as the operation object, from the image that is taken by the CCD camera 100 and taken in through the image input interface 162. For example, as shown in FIG. 3, if the feature points of the engine has been decided in advance to a point P1 and a point P2, the feature point extraction function 192 extracts the points P1, P2 from the image taken by the CCD camera, and it determines the positions of the pixels of the feature points P1, P2 in the image.

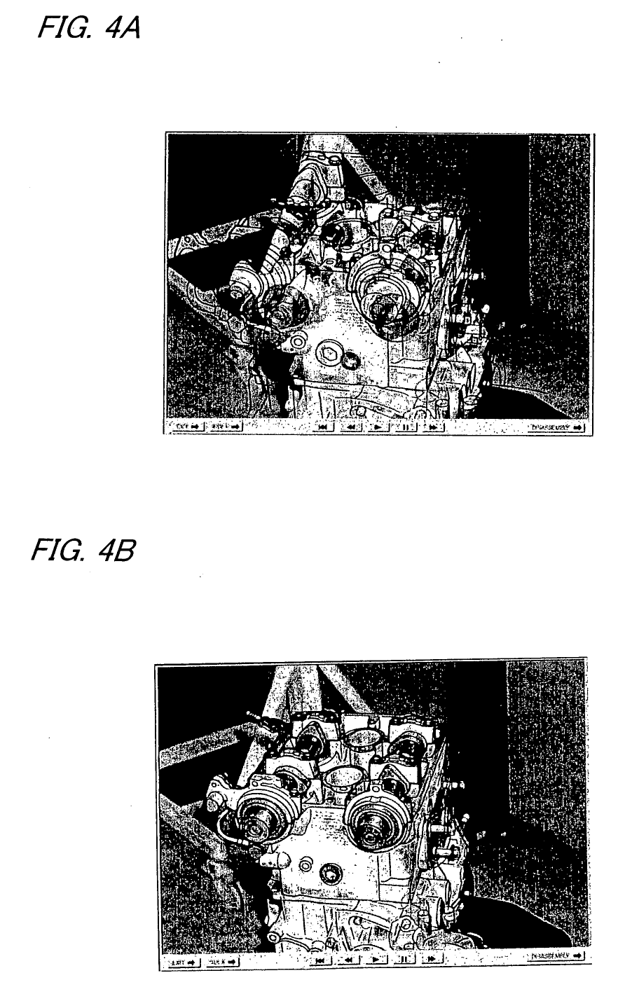

The virtual image control function 193 further includes the virtual image replay function 193A and a virtual image adjusting function 193B. The virtual image replay function 193A calls up the virtual images from the virtual image memory segment 17A to display them on the liquid crystal panels 111 in the order of the operation steps of the engine assembly operation. Furthermore, the virtual image replay function 193A memorizes a correspondence between each of the virtual images and each of the operation steps, and it has a so-called “cue function” that calls up the virtual image corresponding to one of the operation steps that the operator specified using the voice recognition function 191, and it also has a “specified range replay function” that replays the virtual images corresponding respectively to the operation steps within a range specified by the operator and returns to the first virtual image in the specified range after the replay of the virtual images. Of course, the virtual image replay function 193A can fast-forward, rewind, and pause the virtual image(s). The virtual image adjusting function 193B adjusts the virtual image replayed by the virtual image replay function 193A so that the line drawing of the engine drawn on each of the virtual images will have an overlapping relation with the real engine as the real operation object which can be seen through the glass section 11. The adjusting method will be explained below. First, a table that associates the position of each of the pixels of the image data taken by the CCD camera 100 with the position of each of the pixels of the liquid crystal panel 111 is created. The table is stored, for example, in ROM (not shown) in the control section 19. The virtual image adjusting function 193B converts the position, in the image data, of each of the pixels of the feature points P1, P2 extracted from the image data by the feature point extraction function 192, into the position of the corresponding pixel in the liquid crystal panels 111, with reference to the above-mentioned table. Then, the virtual image adjusting function 193B changes the position and/or the dimension of the virtual image automatically so that feature points A, B in the virtual image displayed on the liquid crystal panels 111 that corresponds to the feature points P1, P2 respectively will conform to the positions of the pixels of the feature points P1, P2 respectively on the liquid crystal panels 111. FIG. 4A shows a real engine and a virtual engine displayed on the liquid crystal panels 111 before the virtual image adjusting function 193B adjusts the virtual image. In FIG. 4A, because of the operator's position, etc., the line drawing of the engine drawn on the virtual image is displayed on the liquid crystal panels 111 in a misalignment relation with the real engine seen through the liquid crystal panels 111. FIG. 4B shows the state after the virtual image adjusting function 193B adjusts the virtual image. In FIG. 4B, the line drawing of the engine drawn on the virtual image is displayed in the overlapping relation with the real engine by the virtual image adjusting function 193. The adjustment of the virtual image by the virtual image adjusting function 193 is executed repeatedly in real time.

The voice output function 194 memorizes a correspondence between each of the virtual images and each piece of the voice data stored in the voice memory segment 17B, and it outputs a piece of the voice data corresponding to the virtual image replayed by the virtual image control replay function 193A to the voice output interface 164 in synchronization with the replay of the virtual image.

Now, the operation guiding system 1 constituted as mentioned above is used as follows. In what follows, for the sake of understanding, the assembly operation of the engine is roughly classified into a “step 1”, a “step 2”, . . . , and the operator is to perform the operation called the “step 2”. The step 2 further comprises a “step 2a” and a “step 2b”. In the step 2a, the operator is supposed to fasten bolts to the engine block, and in the step 2b, the operator is supposed to attach an engine cover to the engine block after the step 2a.

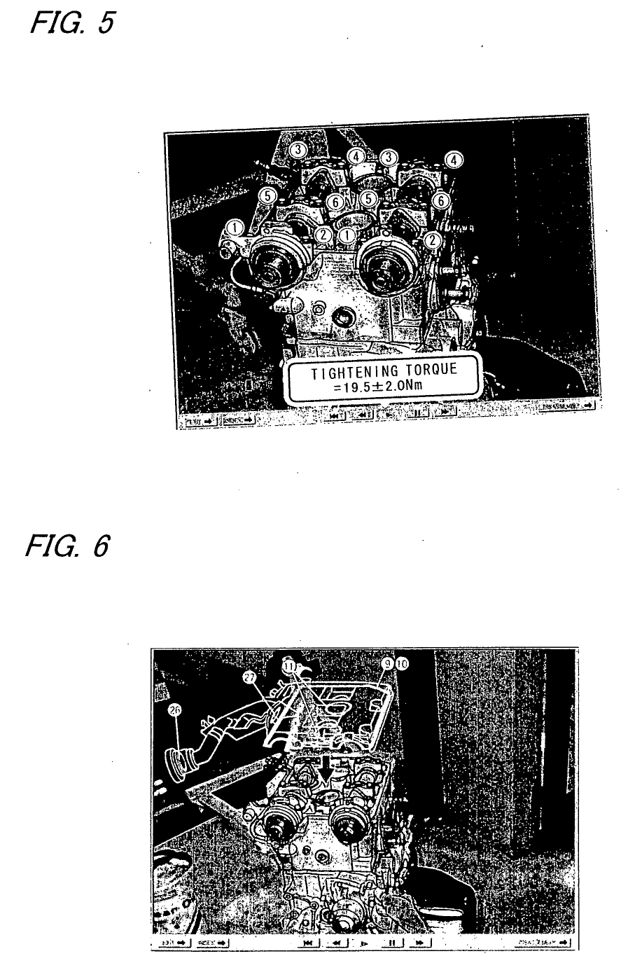

First, the operator puts on the AV unit 10 and sees the unaccomplished engine through the liquid crystal panels 111, as shown in FIG. 3. When the operator says, “Step 2”, toward the microphone 131, the voice recognition function 191 recognizes the term “step 2”, and then the virtual image replay function 193A calls up one virtual image which is a pre-operation image of the step 2 (that is, FIG. 2A.) on the liquid crystal panels 111, using the “cue function”. At that moment, the virtual image adjusting function 193 adjusts the virtual image, so that the virtual image is displayed on the liquid crystal panels 111 in a state where the line drawing of the engine entirely overlaps with the real engine, as shown in FIG. 4B. Next, when the operator says, “Start the replay”, the virtual image replay function 193A replays the virtual image corresponding to the step 2a (that is, FIG. 2B) in accordance with the order of the assembly operation (the step 2a—the step 2b). And the voice explanation is replayed from the headphone speakers 121 by the voice output function 194. FIG. 5 shows a view looked through the liquid crystal panels 111 at that time. The operator watches the display of the liquid crystal panel while listening to the voice explanation, and he fastens the bolts to the engine block in accordance with the virtual images. When the operator has finished fastening the bolts, he says, “Next operation”, and then, the voice recognition function 191 recognizes the term “next operation”, the virtual image replay function 193A replays the virtual image corresponding to the next step, i.e., the “step 2b” (that is, FIG. 2C) on the liquid crystal panels 111. FIG. 6 shows a view looked through the liquid crystal panels 111 at the time. Then, the operator attaches the engine cover to the engine block, while watching the display of the liquid crystal panel and listening to the voice explanation again.

The operator can rewind, pause, or fast-forward the virtual images as needed. The operator may first replay all the virtual images corresponding to the step 2 (that is, FIG. 2A-FIG. 2B-FIG. 2C) continuously using the above-mentioned “specified range replay function” to watch the whole operation, like watching animation, and to understand the whole operation, and then, he may begin the operation. In this case, because the virtual image displayed on the liquid crystal panel will return to the first step in the step 2 (that is, FIG. 2A) after the operator watched the whole virtual images, the operator can easily start the replay of the virtual images from FIG. 2A again and perform the operation in keeping with the replay of the virtual image. The operator can control the replay of the virtual image with hands full of tools, by the voice recognition function 191. Even if the operator moves his head in the middle of the operation, the virtual image adjusting function 193B adjusts the virtual image so that the line drawing of the engine drawn on the virtual image will keep the overlapping relation with the real engine. As explained above, this operation guiding system 1 enables the operator to accurately perform the operation, without an instructor.

Although the memory section 17 is provided within the operation guiding control unit 15 in this embodiment, the memory section 17 may be provided in a server connected to the operation guiding control unit 15 by a wireless or wired LAN. In this case, the operation guiding control unit 15 has a wireless or wired LAN interface. The memory 17 is not limited to the hard disk, but it may be, for example, an optical disk device, a magnetic optical disk device, or a semiconductor memory device.

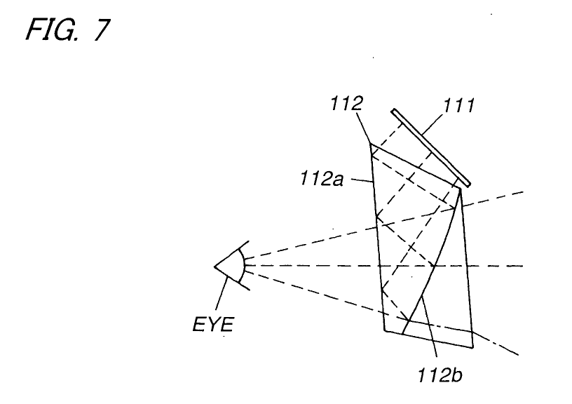

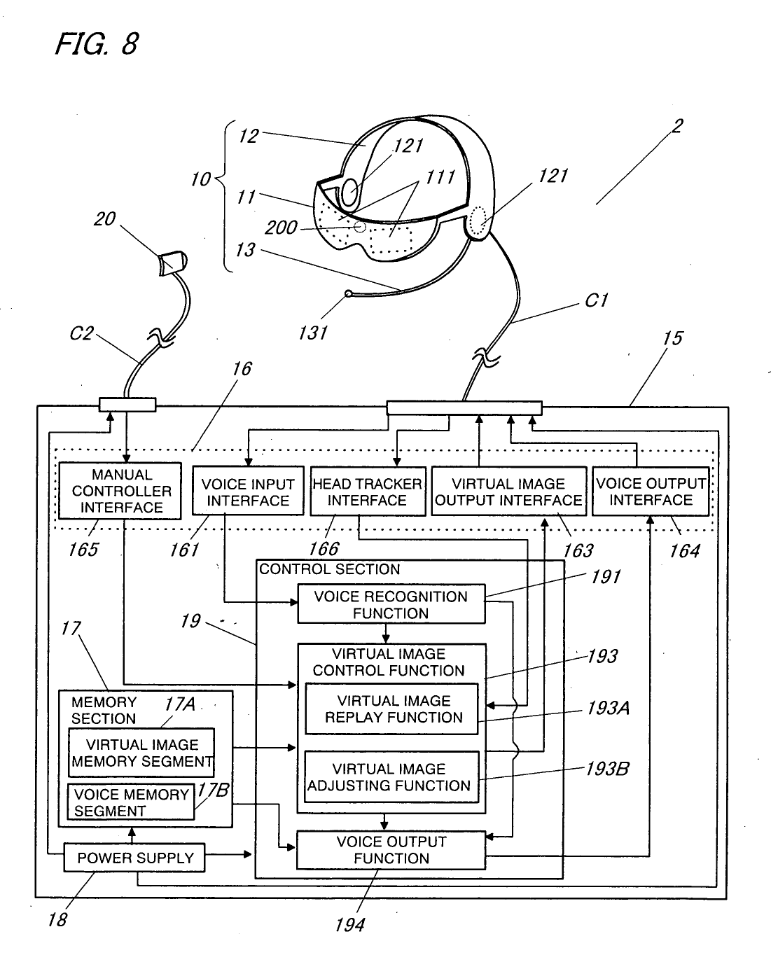

Although the above glass section 11 was the translucent liquid crystal panels 111, it may use a prism shown in FIG. 7. In FIG. 7, the virtual image on the liquid crystal panels 111 enters the prism 112 from one side thereof, and it is totally reflected forward by a reflecting surface 112a on the rear surface of the prism 112, and then it is reflected backward by a half mirror 112b on the front surface of the prism 112, and then it transmits the reflecting surface 112a. As a consequence, the operator can watch the virtual image. On the other hand, the operator can see the operation object itself by an optical path penetrating from the front of the prism 112 to the rear thereof. When the background color of the virtual image is set in black around “000000” (web safe colors) or dark gray around “777777” and the line drawing color of the virtual image is set in light blue around “00FFFF”, the virtual image becomes very clear, in contrast to the operation object itself. Similarly, when the color of the character and the symbol is set in light blue around “00FFFF” or yellow around “FFFF00”, they become very clear. The glass section 11 does not need to have two panels, but it may have one panel. That is, the display unit of the present invention is not limited to a specific one, but it has only to display the virtual image for the operator together with the real operation object in front of the operator.

The virtual image adjusting function 193 does not need to adjust the virtual image in real time, but it may adjust it at specified time intervals.

The “specified range replay function” can replay the virtual images over two or more steps, of course.

It is preferable that the system further includes a visual information mark input means (not shown) that calls up the virtual image from the virtual image memory segment 17A to modify the visual information mark included in the virtual image and/or to add new visual information mark to the virtual image. The visual information mark input means enables the system to respond flexibly to a minimal change of the operation generated at the shop-floor level (for example, a change of a bolting order), so that the operator can perform the operation more effectively. In this case, it is preferable that the virtual image is created separately divided into a layer on which the line drawing outlining the real operation object is drawn and a layer on which the visual information mark is drawn in order to prevent an accidental deletion of the complicated line drawing and to provide a worry-free modification and/or a worry-free addition of the visual information mark.

Although the engine was taken as an example of the operation object in this embodiment, the operation object is not limited to a “thing” like the engine, but it may be a man or an animal. For example, this operation guiding system can be used for teaching someone how to put on the kimono or for checking the procedure of an operation on a man or an animal.

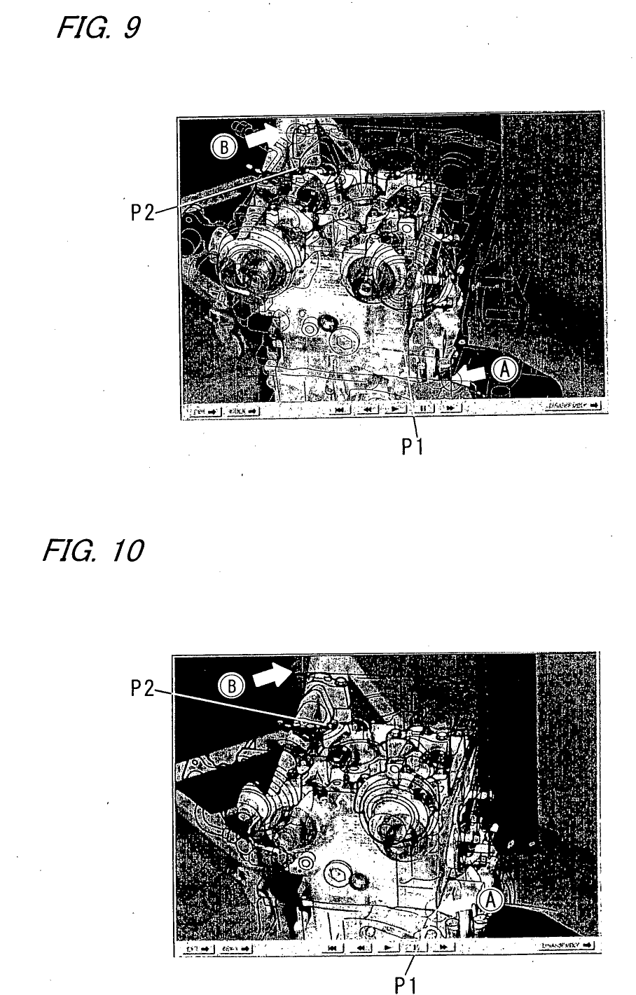

FIG. 9 shows an operation guiding system 2 in accordance with a second embodiment of the present invention. The basic composition of the system 2 is identical to the first embodiment except that the virtual image adjusting function 193B adjusts the virtual image according to a manual intervention. The operation guiding system 2 newly includes a handheld mouse 20 as a manual controller, which is connected to the operation guiding control unit 15. The AV unit 10 includes a head tracker 200 as a head tracking means in the glass section 11 instead of the CCD camera 100. The head tracker 200 tracks a motion of the operator's head. The operation guiding control unit 15 newly includes a manual controller interface 165 and a head tracker interface 166 in the interface section 16. The manual controller interface 165 is connected to the handheld mouse 20, and the head tracker interface 166 is connected to the head tracker 200. The image input interface 162 has been removed from the interface section 16, and the feature point extraction function 192 has been removed from the control section 19.

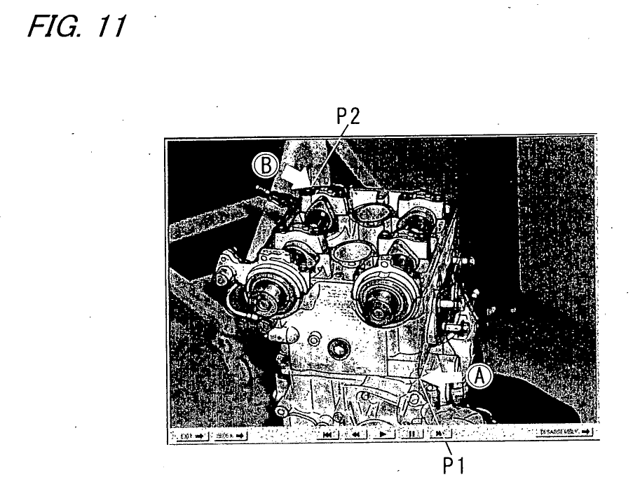

Now, the method for adjusting the virtual image by the virtual image adjusting function 193B will be described below. The control section 19 has a virtual image replay mode and a virtual image adjusting mode, and they are switched to each other by the voice recognition function 191 or the handheld mouse 20. In the virtual image adjusting mode, a feature point decided in advance with respect to the virtual operation object of the virtual image is displayed on the liquid crystal panels 111 in addition to the real operation object and the virtual image. For example, in FIG. 9, feature points A, B of the engine of the virtual image are displayed in addition to the real engine and the virtual engine. In FIG. 9, the real engine and the virtual engine are displayed in a misalignment relation. In such a state, the operator drags the position of the feature point A to a corresponding feature point P1 of the real engine seen through the liquid crystal panes 111, using the handheld mouse 20. At this time, the virtual image adjusting function 193B moves the whole virtual image according to the drag operation. When the operator stops the dragging, the position of the feature point A is fixed (see FIG. 10). Next, the operator drags the position of the feature point B to a corresponding feature point P2 of the real engine. At this time, the virtual image adjusting function 193B changes the size of the whole virtual image with reference to the position of the feature point A. When the operator has finished above mentioned operation, the real engine and the virtual engine of the virtual image are displayed in the overlapping relation, as shown in FIG. 11.

The adjustment executed in the virtual image adjusting mode is applied to all the virtual images stored in the memory section 17, so once the operator adjusts the virtual image in the virtual image adjusting mode, the operator does not need to adjust the virtual image every time the virtual image changes in the subsequent virtual image replay mode.

Even if the operator moves his head in the virtual image replay mode, the head tracker 200 corrects the position of the virtual image automatically, so the virtual image can keep the overlapping relation with the real operation object. Concretely speaking, if the head tracker detects that the operator's head moves to the left, the virtual image adjusting means 193B moves the virtual image to the right as much as the head moves. As the head tracker, an inertial measurement unit which applies an accelerometer or a gyro for the head mounted display can be used.

The method for adjusting the virtual image is not limited to the above-mentioned method. For example, the control section 19 may move automatically into a size change mode after the operator has decided the position of the feature point A. In the size change mode, the size of the whole virtual image is changed with reference to the position of the feature point A according to the moving amount and moving direction of the handheld mouse 20. The virtual image may be able to be adjusted any time except when it is being replayed, without an operator's switching operation from the virtual image reproducing mode to the virtual image adjusting mode.

Instead of the handheld mouse 20, a joy-stick type manual controller or various kinds of pointing device can be used.

1. An operation guiding system comprising:
a virtual image memory configured to store, with respect to an operation composed of a sequence of operation steps, virtual images for explaining a content of each of the operation steps;
a display unit configured to be positioned in front of an operator's eye for displaying the virtual images, in contrast to a real operation object in front of the operator;
a virtual image replay means configured to replay the virtual images on said display unit in order of the operation steps;
a virtual image adjusting means configured to adjust the virtual images such that a virtual operation object drawn on each of the virtual images and corresponding to the real operation object will have an overlapping relation with the real operation object on said display unit.

2. The operation guiding system as set forth in claim 1, wherein
each of the virtual images includes a line drawing outlining the real operation object and a visual information mark for explaining the content of each of the operation steps visually.

3. The operation guiding system as set forth in claim 2, further including
a visual information mark input means which calls up one of the virtual images from said virtual image memory to modify and/or add the visual information mark.

4. The operation guiding system as set forth in claim 3, wherein
each of the virtual images comprises a layer on which the line drawing is drawn and a layer on which the visual information mark is drawn.

5. The operation guiding system as set forth in claim 1, wherein
said virtual image replay means memorizes a correspondence between each of the virtual images and each of the operation steps and has a function that calls up one of the virtual images corresponding to one of the operation steps specified by the operator.

6. The operation guiding system as set forth in claim 1, wherein
said virtual image replay means memorizes a correspondence between each of the virtual images and each of the operation steps, said virtual image replay means having a function that replays the virtual images corresponding to the operation steps within a range specified by the operator and returns to a first virtual image in the range after a replay of the virtual images.

7. The operation guiding system as set forth in claim 1, further including
a voice input means for inputting an operator's voice and
a voice recognition means configured to recognize the voice inputted using said voice input means;
said virtual image replay means controlling the replay of the virtual images based on the operator's voice.

8. The operation guiding system as set forth in claim 1, further including
a voice memory configured to store voice data for explaining the content of each of the operation steps and
a voice output means configured to output the voice data;
said virtual image replay means outputting the voice data to said voice output means in synchronization with a replay of the virtual images.

9. The operation guiding system as set forth in claim 1, further including
an image pickup means configured to take an image of the real operation object and
a feature point extraction means configured to extract a feature point decided in advance with respect to the operation object, from the image taken by said image pickup means;
said virtual image adjusting means changing a position and/or a dimension of each of the virtual images displayed on said display unit automatically such that a point of the virtual operation object which corresponds to the feature point extracted by said feature point extraction means will conform to the position of the feature point.

10. The operation guiding system as set forth in claim 1, wherein
said virtual image adjusting means includes a manual controller by which the operator can manually change a position and/or a dimension of each of the virtual images displayed on said display unit.

11. The operation guiding system as set forth in claim 10, further including
a head tracking means configured to track a motion of the operator's head;
said virtual image adjusting means correcting the position of each of the virtual images displayed on said display unit based on an output of said head tracking means.
